(19) United States
(12) Patent Application Publication
(10) Pub. No.: US 2020/0368653 A1
(43) Pub. Date: Nov. 26, 2020

(54) Adapter For A Filter Assembly

(71) Applicant: Cummins Filtration IP, Inc., Columbus, IN (US)

(72) Inventors: Sandeep T. Thakare, Nashik (IN); Amrapali A. Mahajan, Kolhapur (IN); David S. Baiao, Sorocaba (BR); Denis Y. Iwamoto, Guarulhos (BR); Wassem Abdalla, Cookeville, TN (US); Anil I. Sawant, Pune (IN)

(73) Assignee: Cummins Filration IP, Inc., Columbus, IN (US)

(21) Appl. No.: 16/067,879

(22) PCT Filed: Dec. 30, 2016
(86) PCT No.: PCT/US2016/069446

§ 371 Date: Jul. 3, 2018

Related U.S. Application Data
(60) Provisional application No. 62/275,447, filed on Jan. 6, 2016.

(51) Int. Cl. B01D 35/30; B01D 29/21; B01D 36/00; B01D 17/02

(52) U.S. Cl. CPC B01D 35/306; B01D 29/21; F02M 37/24; B01D 17/02; B01D 36/005

(57) ABSTRACT

A fuel water separator filter having a filter that separates water from a fuel and an adapter having a first end connected to an end of the filter. A second end of the adapter can detachably connect the filter to a plurality of bowls having different sizes. The adapter may detachably connect to the end of the filter or may be permanently connected to the end of the filter. The filter may be a spin-on filter. The adapter may include a first connecting portion that connects to the filter and a second connecting portion that connects to the bowl. The adapter may further include a basin having a plurality of bypass passages that allows the separated water to flow from the filter to the bowl.

### CROSS-REFERENCE TO RELATED PATENT APPLICATION

The present application claims the benefit of priority to U.S. Provisional Patent Application No. 62/275,447, filed Jan. 6, 2016, the contents of which are incorporated herein by reference in its entirety.

### TECHNICAL FIELD

The present application relates generally to fluid filtration systems. More particularly, the present application relates to fuel water separator filter assemblies.

### BACKGROUND

Fuel water separator (FWS) filter assemblies are often utilized to separate emulsified water from fuel, such as diesel fuel, prior to supplying the fuel to an engine of a motor vehicle. In conventional FWS filters, such as that shown in FIG. 1, the filter assembly 10 generally includes a head 12, a filter 14, and a bowl 20. The head 12 is attached to the filter 14 at a first end, while the bowl 20 is attached to the filter 14 at a second end substantially opposite the first end. The filter 14 includes a shell 16 and a filter element 30 disposed within the shell 16. The filter element 30 includes filtration media 32, which circumferentially surrounds a center tube 34 that allows fluid to flow in or out of the filter element 30. The head 12 includes a fluid inlet and a fluid outlet to allow fluid to flow into and out of the filter element 30. The filter element 30 is configured to separate water from the fuel flowing through the filter assembly 10. Separated water is allowed to coalesce and drop into the bowl 20, which includes a drain outlet 22 for removing separated water from the filter assembly 10.

As shown in FIG. 1, the filter 14 may be a spin-on filter that is configured for a rotatable and detachable connection to the head 12 and/or bowl 20, such as by threaded connections. As shown in FIG. 1, the filter 14 is directly coupled to the bowl 20 by a threaded connection 18. Due to this direct connection, the filter 14 typically must be of a certain type and/or size in order to reliably connect to the head 12 and/or bowl 20. If, however, a user desires to connect a different type and/or size of filter, the user is unable to connect the filter to the head and/or bowl. As such, when a different type of filter is needed, the user must also replace the head and/or bowl of the filter assembly in order to use the filter reliably, thereby increasing costs when switching assembly parts.

### SUMMARY

Various embodiments provide for a fuel water separator filter having a filter that separates water from a fuel and an adapter having a first end connected to an end of the filter. A second end of the adapter is configured to detachably connect the filter to a plurality of bowls having different sizes. The adapter may detachably connect to the end of the filter or may be permanently connected to the end of the filter. The filter may comprise a spin-on filter. The adapter may include a first connecting portion that connects to the filter and a second connecting portion that connects to the bowl. The adapter may further include a basin having a plurality of bypass passages that allow the separated water to flow from the filter to the bowl.

Further embodiments provide for an adapter for a fluid water separator filter assembly, comprising a first connecting portion, a second connecting portion, and a basis. The first connecting portion is configured to connect to a filter, the filter configured to separate water from a fluid. The second connecting portion is configured to connect to a bowl, the bowl configured to hold separated water from the filter. The basin has a plurality of bypass passages that allow the separated water to flow from the filter to the bowl.

Still further embodiments provide for a filter assembly, comprising a filter configured to separate water from a fluid; a bowl configured to hold separated water from the filter; and an adapter. The adapter comprises a first connecting portion connected to the filter at an end; a second connecting portion connected to the bowl at an end; and a basin portion having a plurality of bypass passages that allow the separated water to flow from the filter to the bowl.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a cross-sectional view of a conventional fuel water separator filter assembly.

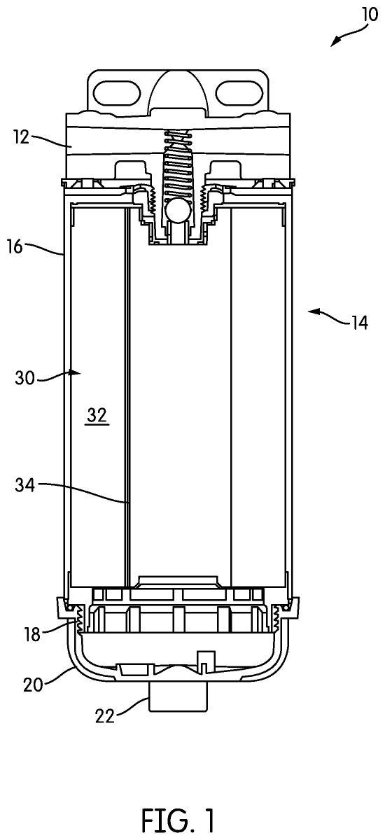

FIG. 2 is a cross-sectional view of a fuel water separator filter assembly, according to an example embodiment.

FIG. 3 is a detailed, sectional view of the fuel water separator filter assembly of FIG. 2.

FIG. 4 is an exploded view of the fuel water separator filter assembly of FIG. 2.

FIGS. 5A-5C are perspective views of an adapter for the fuel water separator filter assembly of FIG. 2.

FIG. 6 is a cross-sectional view showing a flow path for the fuel water separator filter assembly of FIG. 2.

### DETAILED DESCRIPTION OF VARIOUS EMBODIMENTS

Various example embodiments provide for a filter assembly configured to adapt to various bowl connections, without affecting the overall functionality and performance of the filter assembly. In particular embodiments, an adapter is provided that allows a user to connect a non-conventional filter onto a conventional bowl of the filter assembly.

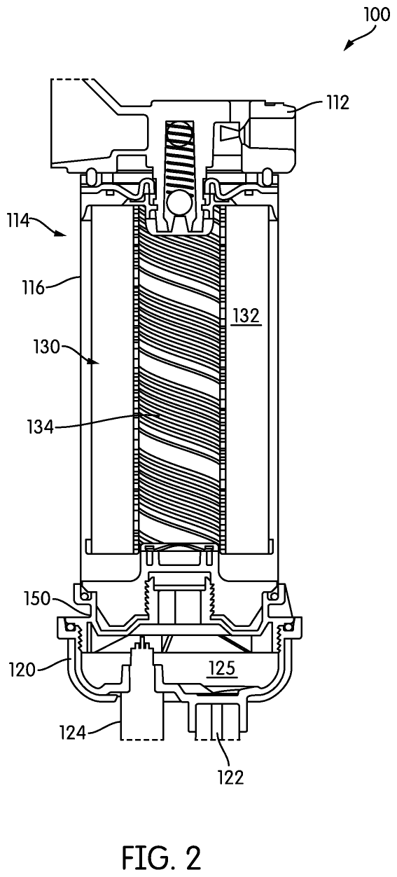

FIG. 2 shows a filter assembly 100 according to an example embodiment. In the embodiment shown in FIG. 2, the filter assembly 100 is a fuel filter for the filtration of fuel. However, the filter 100 is not limited to the filtration of fuel and may be used for the filtration of other fluids, such as lube, oil, air, or the like. In addition, in the embodiment shown in FIG. 2, the filter assembly 100 is configured as a FWS filter assembly. The FWS filter assembly may be configured to remove water contained in a fuel, such as a diesel fuel, before the fuel is introduced into an engine, such as a diesel engine. However, the filter 100 is not limited to the separation of water from fuel and may be configured to separate water from other fluids, such as oil, lube, air, or the like. In addition, the filter assembly 100 is not limited to an FWS filter and may be alternatively configured to function as different types of filters, including, but not limited to, suction side filters.

As shown in FIG. 2, the filter assembly 100 includes a head 112, a filter 114, an adapter 150, and a bowl or reservoir 120. The head 112 is coupled to a first end of the filter 114 via any appropriate connection such as, for example, threaded, welded, or snap-fit connections. The head 112 includes a fluid inlet, which allows a fluid to be filtered to flow into the filter 114, and a fluid outlet, which allows a filtered fluid to flow out of the filter 114.

The filter 114, as shown in FIG. 2, may comprise a spin-on filter that includes an outer shell or housing 116 and a filter element 130. The filter element 130 includes a filtration media 132 that is configured to filter the fluid. The filter media 132 may comprise any appropriate filtration media, such as a pleated filter media or a hydrophobic screen filter. Disposed within the center of the filtration media 132 may be a center tube 134. The center tube 134 may be configured to support the filtration media 132 and/or allow the flow of fluid through the filtration media 134.

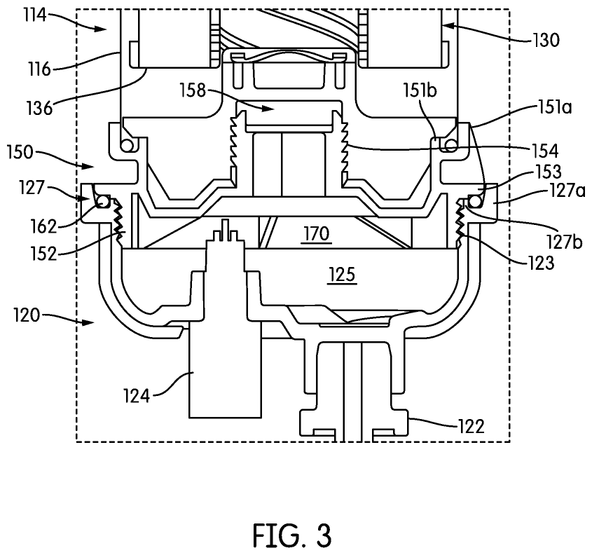

As shown in FIGS. 2 and 3, the bowl 120 is coupled to a second end of the filter 114, which is substantially opposite the first end, via the adapter 150, which is described in more detail below. The bowl 120 is configured to receive and house water that has been separated from the fluid flowing through the filter 114 in an interior space 125. In particular embodiments, the bowl 120 is formed of a clear or translucent material such that a user may view the contents contained within the interior 125 of the bowl 120. In this manner, the user may view the level of the water that is present in the bowl 120 at a given time. In addition, the bowl 120 may be shaped according to any desired configuration. For example, in the example embodiment shown in FIG. 2, the bowl 120 has a dome-like shape. In other embodiments, the bowl 120 may have a rectangular or cylindrical shape.

The bowl 120 may further include a drain outlet 122, which allows water collected in the interior 125 of the bowl 120 to be drained from the filter assembly 100, and a water-in-fuel (WIF) sensor 124, which senses a level of the water present in the interior 125 of the bowl 120. The WIF sensor 124 may be configured to communicate the level of water present in the interior 125 with a control unit (not shown), such as a vehicle's engine control module (ECM). The control unit may be further configured to control the opening and closing of the drain outlet 122 to drain the bowl 120 when the interior 125 is sufficiently filled and/or to alert the user of the need to drain the bowl 120.

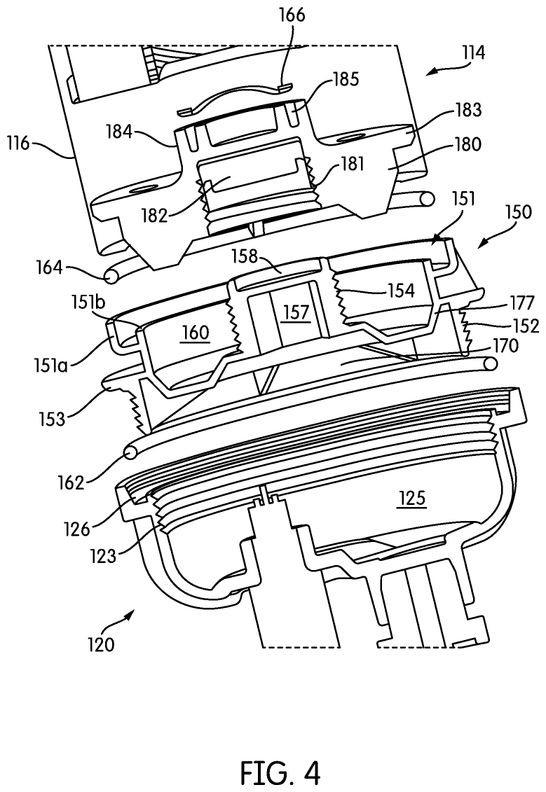

As shown in greater detail in FIGS. 3-5C, the adapter 150 is configured to connect the bowl 120 to the filter 114. On a filter side of the adapter 150 (i.e., the portion of the adapter closest to the filter 114), the adapter 150 is configured to couple to a spin-on connecting portion 180 of the filter 114 via an inner connecting portion 154. As shown in FIGS. 3 and 4, the inner connecting portion 154 is substantially cylindrical in shape and is centrally located within a first outer basin 160. In addition, the inner connecting portion 154 extends axially outward from a bottom surface of the first outer basin 160, described in more detail below, toward the filter 114. The spin-on connecting portion 180 may comprise a secondary adapter for connection to parts of one type of filter assembly, but is of a type that cannot connect to the bowl 120 directly. As shown in the figures, this may be due to, for example, the filter 114 having a smaller diameter than the bowl 120 so as to prevent connection between the filter 114 and the bowl 120 and/or provide sufficient sealing between the filter 114 and the bowl 120. In addition, the configuration of the spin-on connecting portion 180 may prevent connection of the filter 114 to the bowl 120 due to different types of connecting mechanisms (e.g., two female threaded connections). The spin-on connection portion may also be integrally formed with an endcap of the filter 114, or it may comprise a separate component (as shown in FIGS. 2-6).

The spin-on connecting portion 180 is coupled to the shell 116 of the filter 114 by a flange 183, which abuts a filter side surface of a radially inward-extending edge of the shell 116 (as shown in FIG. 4) and may be fixed to the shell 116 via an adhesive or the like. The spin-on connecting portion 180 may further include, on a filter side thereof, an inner protrusion element 184 having an inner well 185. The inner protrusion element 184 extends axially outward toward the filter element 130 and is coupled to the center tube 134 and/or the center of the filtration media 132 via an endcap 136 of the filter element 130, as shown in FIG. 3. The inner well 185 may be a groove that circumferentially extends along a filter side end of the inner protrusion element 184. As shown in FIG. 4, a first seal 166 may be provided within the inner well 185 in order to provide a liquid-tight connection between the spin-on connecting portion 180 and the endcap 136 of the filter 114.

As further shown in FIGS. 3 and 4, the spin-on connecting portion 180 may include an inner recess 182 on an adapter side thereof. The inner recess 182 is shaped substantially the same as the inner connecting portion 154 so as to receive the inner connecting portion 154. The inner recess 182 may include an inner peripheral surface having a female threaded connection 181. In addition, the inner connecting portion 154 of the adapter 150 may include an outer peripheral surface having a male threaded connection, which is configured to mate with the female threaded connection 181 of the spin-on connecting portion 180. The connection between the adapter 150 and the spin-on connecting portion 180, however, is not particularly limited to a threaded connection and may be any other appropriate connection, such as welding, adhesive, snap-fit connection, or the like. In addition, the adapter 150 may be configured to be replaceable and/or detachable from the filter 114 or configured as a permanent structure to the filter 114.

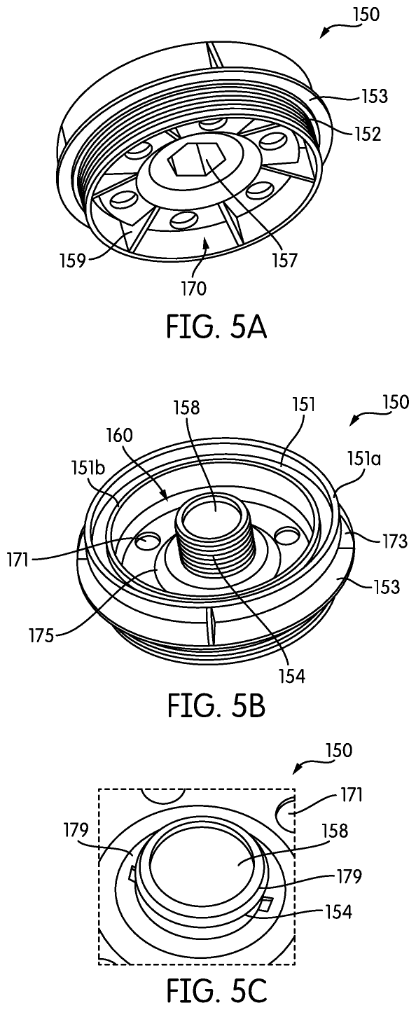

The filter side of the adapter 150 further includes an outer well 151. The outer well 151 extends circumferentially around the first outer basin 160 and includes an outer lip 151a and an inner lip 151b. The outer lip 151a forms an outside circumferential surface of the adapter 150 on the filter side thereof, while the inner lip 151b forms an inside circumferential surface of the first outer basin 160, as shown in FIG. 5B. In addition, as shown in FIG. 3, the outer lip 151a is configured to extend further axially outward toward the filter 114 than the inner lip 151b. The outer well 151 is configured to receive the shell 116 such that a bottom surface of the shell 116 abuts a top surface of the inner lip 151b while an inner surface of the outer lip 151a is substantially flush with the outer peripheral surface of the shell 116. A second seal 164, such as an O-ring, may also be provided in the outer well 151 between the outer lip 151a and the inner lip 151b in order to provide an additional liquid-tight seal between the shell 116 and the adapter 150. As shown in FIG. 5B, a plurality of first ribs 173 may be provided on the outer peripheral surface of the outer lip 151a. The plurality of first ribs 173 may extend from the outer surface peripheral surface of the outer lip 151a to an outer flange 153. The plurality of first ribs 173 may provide additional reinforcement to the adapter 150 and increase ease of handling during assembly.

As further shown in FIG. 4, the filter side of the adapter 150 further includes a second inner basin 158 and the first outer basin 160. As shown in FIGS. 4 and 5B-5C, the second inner basin 158 is formed at a top end of the inner connecting portion 154. The second inner basin 158 may comprise a shallow recess in order to hold an adhesive, such as an epoxy, acrylic, urethane, or the like, such that the threaded connection between the spin-on connecting portion 180 and the adapter 150 may be further improved. In particular embodiments, the second inner basin 158 includes a substantially flat, fully closed bottom surface circumferentially surrounded by a raised rim in order to reliably hold the adhesive as the adapter is installed and prevent contact of the adhesive with a tool during installation. As shown in FIG. 5C, the inner connecting portion 154 may be provided with one or more vertical slots 179. The vertical slots 179 extend axially along the outer peripheral surface of the inner connecting portion 154 in the threaded connection such that the adhesive is allowed to flow downward from the second inner basin 158 and into the threads of the inner connecting portion 154 to further ensure even application of the adhesive on the threaded connection between the spin-on connecting portion 180 and the adapter 150.

To install the adapter 150 to the spin-on connecting portion 180, the adapter 150 may include, on a bowl side thereof, a tool engagement feature 157, shown in FIG. 5A. The tool engagement feature 157 allows a tool to be placed within the tool engagement feature 157 in order to engage the adapter 150 with the spin-on connection portion 180. As shown in FIG. 5A, the tool engagement feature 157 is centrally located on the adapter 150 and is formed as a recess in the bottom surface of an inner concave portion 170 on the bowl side of the adapter 150. In particular embodiments, the tool engagement feature 157 may be in the form of a standard hex feature for mating with a standard hex tool. However, the shape of the tool engagement feature 157 is not limited to a standard hex shape and may be configured to be, for example, rectangular, oval, cross-ribbed, cross-slotted, or the like. As further shown in FIG. 5A, a plurality of second ribs 159 may be further provided along the inner periphery of an outer connecting portion 152 on the bowl side of the adapter 150. The plurality of second ribs 159 extend from the inner peripheral surface of the outer connecting portion 152 to the bottom surface of the inner concave portion 170. The plurality of second ribs 159 may provide additional strength to the adapter 150 in order to prevent fracture or breaking during installation.

As shown in FIGS. 5A-5C, the first outer basin 160 may include a plurality of bypass passages 171 formed along the bottom surface of the first outer basin 160. The bypass passages 171 allow water separated by the filter 114 to flow through the adapter 150 into the bowl 120. In particular embodiments, the bypass passages 171 may be formed as circular orifices, but may be formed as other types of openings, such as rectangular, hex, oval, slotted openings, or the like. The bottom surface of the first outer basin 160 may also be angled such that separated water flowing through the adapter 150 is guided through the bypass passages 171. For example, as shown in FIGS. 5B-5C, an inner sloped portion 175 may be provided on the bottom surface of the first outer basin 160. The inner sloped portion 175 circumferentially surrounds the inner connecting portion 154 and extends downwardly toward the bottom surface of the first outer basin 160 as the inner sloped portion 175 extends radially outward toward the bypass passages 171. In addition, as shown in FIG. 4, the bottom surface of the first outer basin 160 may be angled along an outer circumference of the bottom surface to form an outer sloped portion 177. The outer sloped portion 177 extends radially outward from the inner lip 151b of the outer well 151 and downward at an angle toward the bottom surface of the first outer basin 160 at which the bypass passages 171 are formed. Accordingly, separated water is prevented from collecting in the adapter 150 and is instead reliably guided through the bypass passages 171 of the adapter 150 and into the bowl 120 by the inner sloped portion 175 and the outer sloped portion 177.

On the bowl side of the adapter 150, the adapter 150 includes an outer connecting portion 152. The outer connecting portion 152 forms an outside circumferential surface of the adapter 150 on the bowl side thereof and the inner circumferential surface of the inner concave portion 170. The outer connecting portion 152 is configured to detachably connect with an inner surface of the bowl 120. In the example embodiment shown, the outer connecting portion 152 includes on its outer peripheral surface a male threaded connection. The inner surface of the bowl 120 includes a female threaded connection 123, which is configured to mate with the outer connecting portion 152. The connection between the adapter 150 and the bowl 120, however, is not particularly limited to a threaded connection and may be any other appropriate detachable connections, such as a snap-fit connection or the like.

The adapter 150 further includes the outer flange 153, which circumferentially surrounds an outside of the adapter 150 and is located above the outer connecting portion 152 and below the outer well 151. In addition, when the adapter 150 is connected to the bowl 120, the outer flange 153 is configured to be substantially flush with the top of an inner lip 127b of the inner well 127 and the inside surface of an outer lip 127a of the inner well 127 formed along the rim of the bowl 120. Disposed within the inner well 127 between the outer lip 127a and the inner lip 127b may be a third seal 162, which may be an O-ring, such that a liquid-tight connection between the bowl 120 and the adapter 150 may be provided. In particular embodiments, the outer flange 153 extends radially outward further than an inner lip 127b of the inner well 127 of the bowl 120 such that the bottom surface of the outer flange 153 provides a sufficient axial sealing surface for the bowl 120. Moreover, by extending a sufficient length radially outward, the outer flange 153 can provide a sufficient sealing surface to a variety of different bowl sizes and types.

As further shown in FIGS. 3 and 4, the bowl side of the adapter 150 includes the inner concave portion 170. The inner concave portion 170 is shaped and configured such that the volume contained within the interior space 125 of the bowl 120 (e.g., the sump volume) remains substantially the same as compared to when a filter of a type configured to directly connect to the bowl 120 is used. Accordingly, the amount of water that can be held or reserved by the interior space 125 of the bowl 120 remains unaffected even when a different type of filter is connected to the bowl 120 via the adapter 150. Moreover, the inner concave portion 170 is configured to provide sufficient clearance to prevent impeding the function of the drain valve 122 and the WIF sensor 124 attached to the bowl 120.

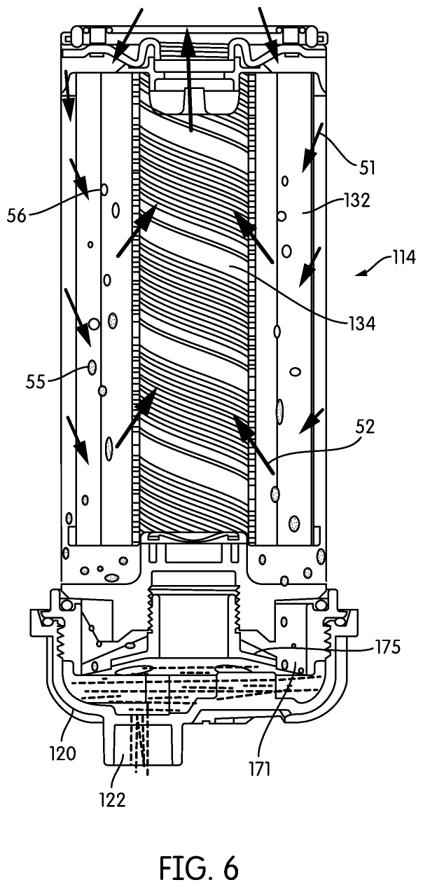

FIG. 6 shows an example of a fluid flow process through the filter assembly 100. In the particular embodiment shown in the figure, the filter 114 is configured to have an outside-to-inside flow pattern, but may be alternatively configured to have an inside-to-outside flow pattern. As shown in FIG. 6, fluid to be filtered 51 first enters the filter 114 though an inlet contained in the head (not shown) into the filter element 130. The fluid then flows through the filtration media 132. Impurities 56, in the form of contaminants and/or debris, are removed from the fluid as it flows through the filtration media 32. At the same time, water is also removed from the fluid in the filtration media. Water droplets 55 coalesce and fall downward toward the bottom of the filter 114. Because of the bypass passages 171 formed in the adapter 150, the water droplets 55 flow through the adapter 150 and into the bowl 120. Moreover, due to the inner sloped portion 175 and the outer sloped portion 177 contained within the first outer basin 160 of the adapter 150, the water droplets 55 are guided through the bypass passages 171 into the bowl 120. Filtered fluid 52 flows out of the filtration media 130 into the center tube 134, where the filtered fluid 52 then flows upward and out of the filter 114 through an outlet contained in the head (not shown). Separated water droplets 55, in turn, flow out of the bowl 120 through the drain outlet 122.

The adapter described herein provides a cost-effective solution that allows a user to use the same type and/or size of filter with a variety of bowl sizes and types, while maintaining the overall function and performance of the filter assembly and providing sufficient sealing to prevent water or other impurities from entering the filter. In addition, the simple design of the adapter may allow for easy installation onto the filter and the bowl, thereby further reducing costs associated with installation. Moreover, the adapter is structurally stable such that a sufficient connection is maintained between the filter and the bowl during use and over the lifetime of the filter assembly.

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

1. A fuel water separator filter, comprising:
a filter configured to separate water from a fuel; and
an adapter having a first end connected to an end of the filter and a second end configured to detachably connect the filter to a plurality of bowls having different sizes.

2. The fuel water separator filter of claim 1, wherein the adapter is detachably connected to the end of the filter.

3. The fuel water separator filter of claim 1, wherein the adapter is permanently connected to the end of the filter.

4. The fuel water separator filter of claim 1, wherein the filter comprises a spin-on filter.

5. An adapter for a fluid water separator filter assembly, comprising:
a first connecting portion configured to connect to a filter, the filter configured to separate water from a fluid;
a second connecting portion configured to connect to a bowl, the bowl configured to hold separated water from the filter; and
a basin having a plurality of bypass passages that are formed along a bottom surface of the basin and that allow the separated water to flow from the filter to the bowl,
the basin comprising an outer sloped portion extending radially outward and upward at an angle from an outer circumference of the bottom surface of the basin.

6. The adapter of claim 5, further comprising an outer well extending circumferentially around the basin, the outer well including an inner lip that forms an inside circumferential surface of the basin and an outer lip that forms an outside circumferential surface of the adapter.

7. The adapter of claim 6, wherein the outer lip extends further axially outward than the inner lip.

8. The adapter of claim 6, further comprising an outer flange extending circumferentially around the outside circumferential surface of the adapter.

9. The adapter of claim 8, further comprising a plurality of ribs extending from the outer lip to the outer flange.

10. The adapter of claim 5, further comprising a second basin formed at a top end of the first connecting portion, wherein the second basin comprises a shallow recess.

11. The adapter of claim 10, further comprising one or more vertical slots extending axially along an outer peripheral surface of the first connecting portion.

12. The adapter of claim 6, wherein the basin is provided on a filter side of the adapter.

13. The adapter of claim 12, further comprising:
an inner concave portion provided on a bowl side of the adapter; and
a tool engagement feature formed as a recess in a bottom surface of the inner concave portion.

14. The adapter of claim 5, wherein the bypass passages are formed as circular orifices.

15. The adapter of claim 6, wherein the basin further comprises an inner sloped portion circumferentially surrounding the first connecting portion and extending downwardly toward the bottom surface of the basin as the inner sloped portion extends radially outward from the first connecting portion.

16. The adapter of claim 15, wherein the outer sloped portion extends radially outward from the inner lip and downward at an angle toward the bottom surface of the basin.

17. A filter assembly, comprising:
a filter configured to separate water from a fluid;
a bowl configured to hold separated water from the filter; and
an adapter comprising:
a first connecting portion connected to the filter at an end;
a second connecting portion connected to the bowl at an end; and
a basin portion having a plurality of bypass passages that are formed along a bottom surface of the basin and that allow the separated water to flow from the filter to the bowl,
the basin portion comprising an outer sloped portion extending radially outward and upward at an angle from an outer circumference of the bottom surface of the basin.

18. The filter assembly of claim 17, wherein the adapter further comprises an outer well extending circumferentially around the basin, the outer well including an inner lip that forms an inside circumferential surface of the basin and an outer lip that forms an outside circumferential surface of the adapter.

19. The filter assembly of claim 18, wherein a top surface of the inner lip abuts a bottom surface of the filter.

20. The filter assembly of claim 19, wherein an inner surface of the outer lip abuts an outer peripheral surface of the filter.
